(19) United States
(12) Patent Application Publication
(10) Pub. No.: US 2023/0274316 A1
(43) Pub. Date: Aug. 31, 2023

(54) INFORMATION DISPLAYING APPARATUS, INFORMATION DISPLAYING METHOD, AND PROGRAM

(71) Applicant: Sony Group Corporation, Tokyo (JP)

(72) Inventors: Shin TAKANASHI, Tokyo (JP); Masao ERIGUCHI, Tokyo (JP)

(73) Assignee: Sony Group Corporation, Tokyo (JP)

(21) Appl. No.: 18/017,857

(22) PCT Filed: Jun. 15, 2021
(86) PCT No.: PCT/JP2021/022627

§ 371 Date: Jan. 25, 2023

(30) Foreign Application Priority Data
Aug. 21, 2020 (JP) 2020-139937

(51) Int. Cl. G06Q 30/0251; G09F 21/04; G06V 20/56

(52) U.S. Cl. CPC G06Q 30/0265; G09F 21/0485; G06V 20/56

(57) ABSTRACT

An information displaying apparatus includes an information display disposed on a vehicle and oriented so content displayed on the information display is visible outside of the vehicle; and circuitry configured to control the content displayed on the information display, wherein in a first mode the content includes distribution information provided from a content server and in a second mode the content includes captured image information captured by a camera disposed on the vehicle.

### CROSS REFERENCE TO RELATED APPLICATIONS

This application claims the benefit of Japanese Priority Patent Application JP 2020-139937 filed Aug. 21, 2020, the entire contents of which are incorporated herein by reference.

### TECHNICAL FIELD

The present technology relates to an information displaying apparatus, an information displaying method, and a program and makes it possible to effectively perform information provision of an advertisement or the like by using a vehicle.

### BACKGROUND ART

A system has been proposed in which an advertisement is displayed on a moving object. For example, PTL 1 discloses a system and a method in which income is obtained by displaying advertisement content and other kinds of sound/video information on an external surface of a movable object.

### CITATION LIST

### Patent Literature

PTL 1: Japanese Patent Laid-Open No. 2016-66358

### SUMMARY

### Technical Problems

Incidentally, in PTL 1, a display panel is designed such that it is mounted vertically at a seat metal portion of a lower-rear portion hatch or is mounted horizontally such that it is viewed through a rear window of a SUV (Sport Utility Vehicle) to provide an excellent viewing gaze to an occupant of a subsequent automobile without consuming an internal space or automobile accessory equipment by a large amount. Therefore, it is difficult to secure a wide advertisement area and is complicated in attachment, making it difficult to effectively perform information provision.

Therefore, it is desirable for the present technology to provide an information displaying apparatus, an information displaying method, and a program that make it possible to effectively perform information provision of an advertisement and so forth using a vehicle.

### Solution to Problems

The first mode of the present technology resides in an information displaying apparatus including an information displaying section provided on a vehicle, and a display controlling section that causes the information displaying section to display provision information provided from an information provision side and captured image information in an image capturing direction different from a displaying direction of the information displaying section.

In this technology, the information displaying section is provided removably or fixedly on a rear face or a side face of the vehicle inside or outside the vehicle such that the displaying direction is set as an outward direction. The display controlling section causes the information displaying section to display provision information provided from the information provision side and captured image information in the image capturing direction different from the displaying direction of the information displaying section. Further, the display controlling section creates and outputs display history information regarding the provision information.

The information displaying section is, for example, provided on a rear face of the vehicle such that the displaying direction is set as a rearward direction of the vehicle, and the display controlling section causes the information displaying section to display the provision information and captured image information in which the image capturing direction is set as a forward direction of the vehicle. Also, the display controlling section controls information to be displayed by the information displaying section according to operation of the vehicle, and switches information to be displayed by the information displaying section between the provision information and the captured image information on the basis of a switching determination condition according to the operation of the vehicle. Further, the display controlling section changes a display attribute of information to be displayed by the information displaying section according to operation of the vehicle. Further, the display controlling section selects provision information according to a peripheral environment.

Further, the information displaying apparatus further includes a recognition section that performs a recognition process using a peripheral captured image obtained by imaging an area around the vehicle and captured image information obtained by capturing the rear of the vehicle, for example, and the display controlling section selects provision information to be displayed from the provided provision information on the basis of a result of the recognition of the recognition section. The recognition section outputs the result of the recognition to the information provision side, and the display controlling section acquires provision information selected on the basis of the result of the recognition on the information provision side due to outputting of the result of the recognition.

The display controlling section performs a display correction process of the provision information and the captured image information according to the displaying direction of the information displaying section. Further, the display controlling section performs display effect prediction and selects provision information to be displayed from the provided provision information on the basis of a result of the prediction.

Further, electric power necessary for operation of the information displaying section and the display controlling section is supplied from a power supply provided separately from a driving power supply of the vehicle.

The second mode of the present technology resides in an information displaying method including causing a display controlling section to cause an information displaying section which is provided on a vehicle, to display provision information provided from an information provision side and captured image information in an image capturing direction different from a displaying direction of the information displaying section.

The third mode of the present technology resides in a program for causing a computer to execute information display by an information displaying section provided on a vehicle, the program including acquiring provision information provided from an information provision side, acquiring captured image information in an image capturing direction different from a displaying direction of the information displaying section, and causing the information displaying section to perform information display using the provision information and the captured image information.

It is to be noted that the program of the present technology is a program capable of being provided by a storage medium or a communication medium provided in a computer-readable form such as, for example, a storage medium such as an optical disc, a magnetic disk or a semiconductor memory, or a communication medium such as a network for, for example, a general-purpose computer capable of executing various program codes. By providing such a program as just described in a computer-readable form, processes corresponding to a program are executed in a computer.

### BRIEF DESCRIPTION OF DRAWINGS

FIG. 1 is a view depicting an information provision system.

FIG. 2 is a view depicting a configuration of an information displaying apparatus and an information provision apparatus.

FIG. 3 is a flow chart depicting operation of the information displaying apparatus and the information provision apparatus.

FIG. 4 is a view exemplifying an appearance of a vehicle.

FIG. 5 is a view depicting an example of a functional configuration of the vehicle.

FIG. 6 is a view depicting an example of sensing regions.

FIG. 7 is a view depicting an example of display of an image displaying section.

### DESCRIPTION OF EMBODIMENT

In the following, a mode for carrying out the present technology is described. It is to be noted that the description is given in the following order.
1. Information Provision System
2. Configuration and Operation of Information Displaying Apparatus and Information Provision Apparatus
3. Example of Configuration and Example of Operation of Vehicle in Which Information Displaying Apparatus Is Used

### 1. Information Provision System

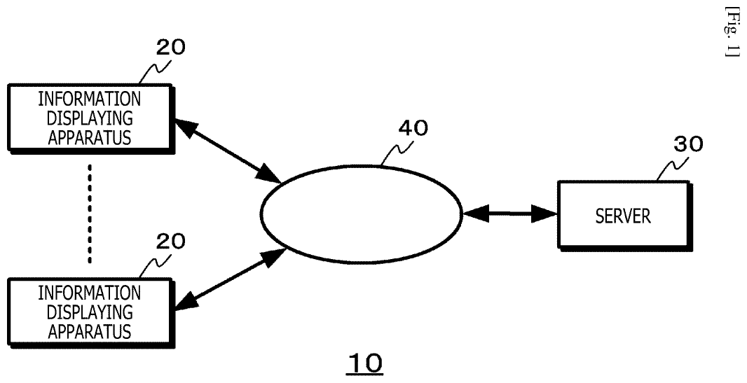

FIG. 1 exemplifies a configuration of an image provision system in which an image displaying apparatus of the present technology is used. An information provision system 10 includes an information displaying apparatus 20, and an information provision apparatus 30 such as a server (e.g., content server, or computer that is a source of content conveyed wirelessly to the information displaying apparatus 20) that manages provision of information to be displayed on the information displaying apparatus 20 and display performances. While the term “provision information” is used herein, it may be construed as distribution information that is provisioned from an external source. The information displaying apparatus 20 and the information provision apparatus 30 are connected to each other through a network 40.

The information displaying apparatus 20 is provided on a vehicle, and displays information regarding an advertisement and so forth provided from the information provision apparatus 30 (such information is hereinafter referred to also as “provision information”) and transmits information indicative of a display situation (also referred to as “display history information”) to the information provision apparatus 30. The information provision apparatus 30 manages display performances of provision information on the basis of the display history information from the information displaying apparatus 20 and gives an incentive according to the display performances to a manager of the information displaying apparatus 20. It is to be noted that it is sufficient if the provision information is information to be presented to people around the vehicle and the provision information is not limited to an advertisement. Further, as the incentive, not only a monetary payment may be offered, but also a discount rate for car insurance may be offered, or the like. Alternatively, the incentive may be given as a taxi fare discount or as offering of an in-car service.

### 2. Configuration of Information Displaying Apparatus and Information Provision Apparatus

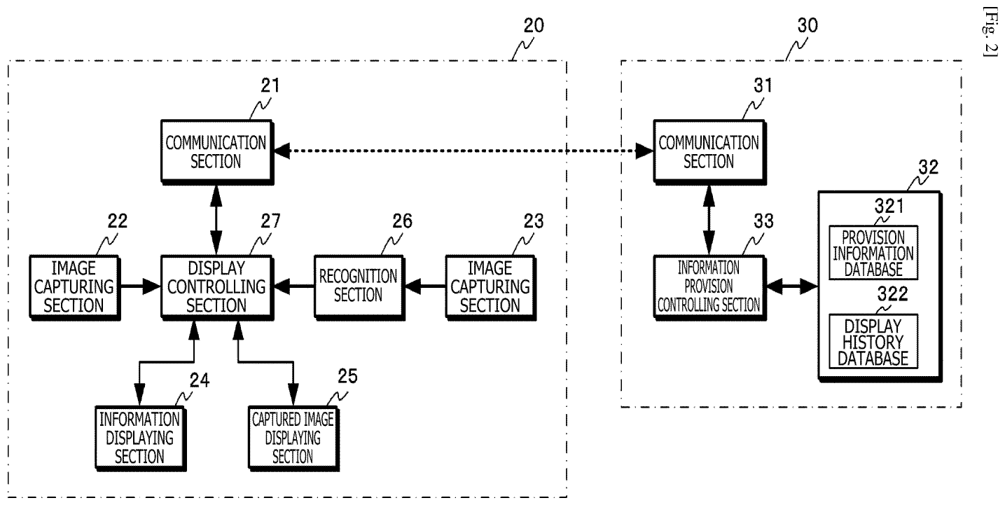

FIG. 2 depicts a configuration of the information displaying apparatus and the information provision apparatus. The information displaying apparatus 20 includes a communication section 21, image capturing sections 22 and 23, an information displaying section 24, a captured image displaying section 25, and a display controlling section 27. The information displaying apparatus 20 may further include a recognition section 26.

The communication section 21 performs communication with the information provision apparatus 30 and outputs provision information transmitted from the information provision apparatus 30 to the display controlling section 27. Further, the communication section 21 transmits display history information and a recognition result hereinafter described generated by the display controlling section 27 to the information provision apparatus 30.

The image capturing section 22 images, for example, in a forward moving direction (the front) of the vehicle in which the information displaying apparatus 20 is provided and outputs captured image information obtained to the display controlling section 27. Meanwhile, the image capturing section 23 captures an image in a second direction different from that of the image capturing section 22, for example, images from a rearward direction of the vehicle on which the information displaying apparatus 20 is provided, and outputs captured image information obtained to the recognition section 26.

In this embodiment, the information displaying section 24 is provided removably or fixedly on a rear face or a side face of the vehicle inside or outside the vehicle such that a displaying direction is set as an outward direction, so content on the information displaying section 24 is visible to an observer outside of the vehicle. For example, the information displaying section 24 is provided such that a person positioned in the rear of the vehicle that is the second direction can view information displayed thereon. The information displaying section 24 performs displaying operation under the control of the display controlling section 27.

The captured image displaying section 25 is provided such that it can be viewed by a person in the vehicle. The captured image displaying section 25 is provided such that it displays, for example, a captured image of the rear of the vehicle that is the second direction to allow, even if the field of view of the rear of the vehicle is blocked by the provision of the information displaying section 24, the rear of the vehicle to be confirmed from the captured image information displayed by the captured image displaying section 25.

The recognition section 26 performs a recognition process using captured image information obtained by the image capturing section 23 and outputs a result of the recognition to the display controlling section 27.

The display controlling section 27 causes the information displaying section 24 to display provision information provided from the information provision apparatus 30. Further, in a case in which the recognition section 26 is provided, the display controlling section 27 causes the information displaying section 24 to display provision information selected on the basis of a result of the recognition by the recognition section 26 from the provision information provided thereto or provision information selected by and transmitted from the information provision apparatus 30 according to notification of the result of the recognition to the information provision apparatus 30 or else provision information selected according to a peripheral environment from the provision information provided from the information provision apparatus 30. Further, the display controlling section 27 controls information to be displayed by the information displaying section 24 according to operation of the vehicle. Furthermore, the display controlling section 27 generates display history information indicative of display performances of provision information and transmits the display history information to the information provision apparatus 30 through the communication section 21. In addition, the display controlling section 27 causes the captured image displaying section 25 to display captured image information acquired by the image capturing section 23 in such a manner as described above. Further, the display controlling section 27 performs change of a display attribute for provision information or captured image information according to operation of the vehicle such that the visibility of information to be displayed by the information displaying section 24 becomes better.

The information provision apparatus 30 includes a communication section 31, a database section 32, and an information provision controlling section 33. Further, the database section 32 includes a provision information database 321 and a display history database 322.

The communication section 31 communicates with the information displaying apparatus 20 and transmits provision information. Further, the communication section 31 receives display history information from the information displaying apparatus 20 and outputs the display history information to the information provision controlling section 33.

The provision information database 321 of the database section 32 has stored therein various kinds of provision information which can be displayed on the information displaying apparatus 20 in an associated relation with information providers, and selects and outputs provision information on the basis of an instruction from the information provision controlling section 33 to the communication section 31.

The display history database 322 of the database section 32 stores, for each information displaying apparatus, manager information, display history information, and so forth of the information displaying apparatus.

The information provision controlling section 33 selects provision information to be displayed on the information displaying apparatus 20 from the provision information database 321 on the basis of a selection condition set in advance. For example, the information provision controlling section 33 selects provision information on the basis of a provision period, provision time, related information regarding the information displaying apparatus 20 (for example, a current position, movement history information, and so forth of a vehicle), and so forth and causes the selected provision information to be transmitted from the communication section 31 to the information displaying apparatus 20. Further, in a case in which a recognition result generated by the information displaying apparatus 20 is received, the information provision controlling section 33 selects one or more pieces of provision information from the provision information database 321 on the basis of the recognition result and causes the selected provision information to be transmitted from the communication section 31 to the information displaying apparatus 20.

Further, the information provision controlling section 33 causes display history information generated by the information displaying apparatus 20 to be stored into the display history database 322. The information provision controlling section 33 gives an incentive according to display performances for each information displaying apparatus to the manager of the information displaying apparatus on the basis of the display history information stored in the display history database 322. For example, the information provision controlling section 33 notifies an information provider associated with the displayed provision information of its display performance history information and gives an incentive from the information provision apparatus (or information provider) to the manager of the information displaying apparatus.

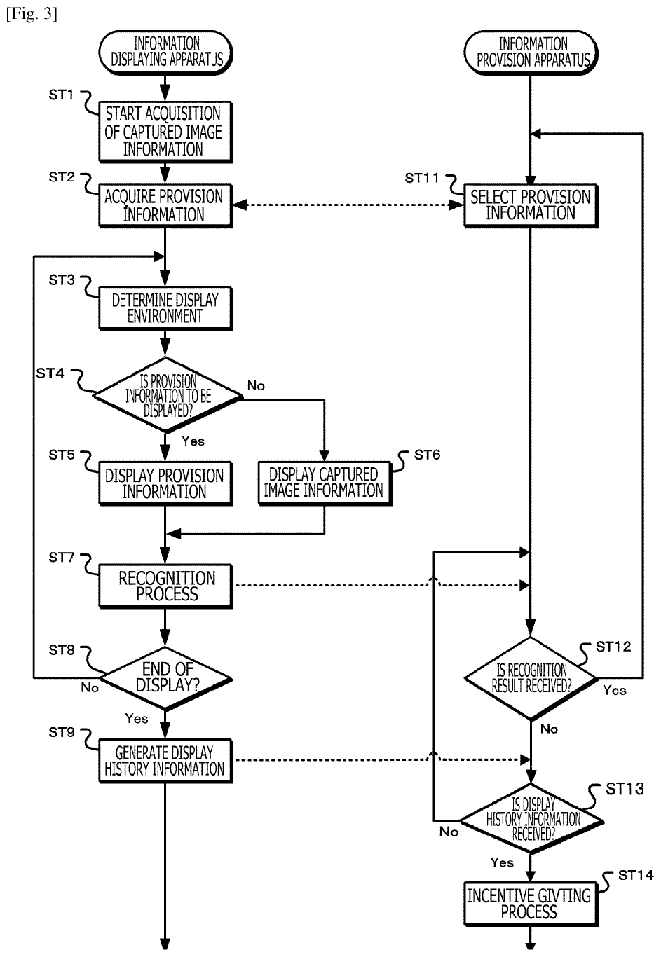

Now, operation of the information displaying apparatus and the information provision apparatus is described. FIG. 3 is a flow chart depicting operation of the information displaying apparatus and the information provision apparatus.

At step ST1, the information displaying apparatus starts acquisition of captured image information. The information displaying apparatus 20 starts acquisition of captured image information from the image capturing sections 22 and 23 and advances its processing to step ST2.

At step ST11, the information provision apparatus 30 selects provision information. The information provision apparatus 30 selects one or a plurality of pieces of provision information to be displayed on the information displaying apparatus 20 on the basis of a selection condition set in advance and transmits the selected provision information to the information displaying apparatus 20. Then, the information provision apparatus 30 advances the processing to step ST12.

At step ST2, the information displaying section acquires provision information. The information displaying apparatus 20 receives the provision information transmitted from the information provision apparatus 30 and advances the processing to step ST3.

At step ST3, the information displaying apparatus determines a display environment. The information displaying apparatus 20 performs processes, for example, luminance adjustment and display size adjustment, for the provision information provided at step ST3 and the captured image information acquired at step ST1 on the basis of an operation state and surrounding environments of the information displaying apparatus 20 and a display performance, arrangement, and so forth of the information displaying section 24 such that the provision information and the captured image information to be displayed on the information displaying section 24 are displayed with good visibility. Further, for example, in a case in which the information displaying section 24 is mounted in an inclined posture, the information displaying apparatus 20 performs a display correction process and so forth such that the display can be recognized without being influenced by the inclination.

At step ST4, the information displaying apparatus determines whether or not the provision information is to be displayed. The information displaying apparatus 20 controls the information to be displayed on the information displaying section according to operation of the vehicle, and advances the processing to step ST5 in a case in which the display condition of the provision information is satisfied, and advances the processing to step ST6 in a case in which the display condition of the provision information is not satisfied.

At step ST5, the information displaying apparatus displays the provision information. The information displaying apparatus 20 causes the information displaying section 24 to display the provision information provided from the information provision apparatus 30 or provision information selected according to the surrounding environment from the provision information provided thereto, and advances the processing to step ST7.

At step ST6, the information displaying apparatus displays the captured image information. The information displaying apparatus 20 causes the information displaying section 24 to display the captured image information acquired by the image capturing section 22 and advances the processing to step ST7.

At step ST7, the information displaying apparatus performs a recognition process. The information displaying apparatus 20 performs the recognition process using the captured image information acquired by the image capturing section 23. Further, the information displaying apparatus 20 may switch the provision information on the basis of the result of the recognition or may transmit the result of the recognition to the information provision apparatus 30. The information displaying apparatus performs the recognition process and advances the processing to step ST8.

When the processing advances from step ST11 to step ST12, the information provision apparatus 30 determines whether or not a result of a recognition is received. In a case in which the information provision apparatus 30 receives the result of the recognition transmitted by the process performed at step ST7 by the information displaying apparatus 20, the information provision apparatus 30 returns the processing to step ST11 and selects and transmits provision information according to the result of the recognition to the information displaying apparatus 20. In contrast, in a case in which a result of a recognition is not received, the information provision apparatus 30 advances the processing to step ST13.

The information displaying apparatus 20 determines at step ST8 whether the display is to be ended. In a case in which the display of information using the information displaying section 24 is to be ended, the information displaying apparatus 20 advances the processing to step ST9, and in a case in which the display of information is not to be ended, the information displaying apparatus 20 returns the processing to step ST3.

At step ST9, the information displaying apparatus generates display history information. The information displaying apparatus 20 generates display history information that includes, for example, name and display period information regarding the provision information displayed on the information displaying section 24 (for example, a display accumulation time period, display start time and display end time, and so forth), display position information that makes it possible to determine at which position the provision information is displayed, identification information set in advance to the information displaying apparatus on which the presentation information is displayed, and so forth. Further, the information displaying apparatus 20 transmits the generated display history information to the information provision apparatus 30.

The information provision apparatus 30 determines whether or not display history information is received at step ST13. In a case in which the information provision apparatus 30 receives the display history information transmitted from the information displaying apparatus 20 as a result of the process performed at step ST9, it advances the processing to step ST14, and in a case in which the information provision apparatus 30 does not receive the display history information, it advances the processing to step ST12.

At step ST14, the information provision apparatus 30 performs a process of giving an incentive. The information provision apparatus 30 stores the received display history information into the display history database 322. Further, the information provision apparatus 30 gives an incentive, for example, to the manager of the information displaying apparatus 20 according to the display performances of the presentation information by the information displaying apparatus 20 on the basis of the information display history of the information displaying apparatus 20 stored in the display history database 322.

It is to be noted that the operation of the information displaying apparatus and the information provision apparatus is not limited to the operation depicted in FIG. 3. For example, the processes at step ST2 and step ST11 may be performed in advance, and at the time of start of operation of the information displaying apparatus, provision information may be acquired. Further, it is not restrictive that display history information is generated by the information displaying apparatus 20 and transmitted to the information provision apparatus 30 at steps ST9, and the display history information may otherwise be generated and transmitted every time a predetermined period of time elapses.

In this manner, in the information displaying apparatus, since the information displaying section is provided removably or fixedly on a rear face or a side face of the vehicle inside or outside the vehicle such that a displaying direction is set as an outward direction, it is possible to assure a wide advertisement area to perform information provision of an advertisement and so forth. Further, since the information displaying apparatus can be mounted also on an existing vehicle and the information provision apparatus gives an incentive according to display performances of information, a vehicle that can provide information regarding an advertisement or the like can be increased easily.

### 3. Example of Configuration and Example of Operation of Vehicle in Which Information Displaying Apparatus is Used

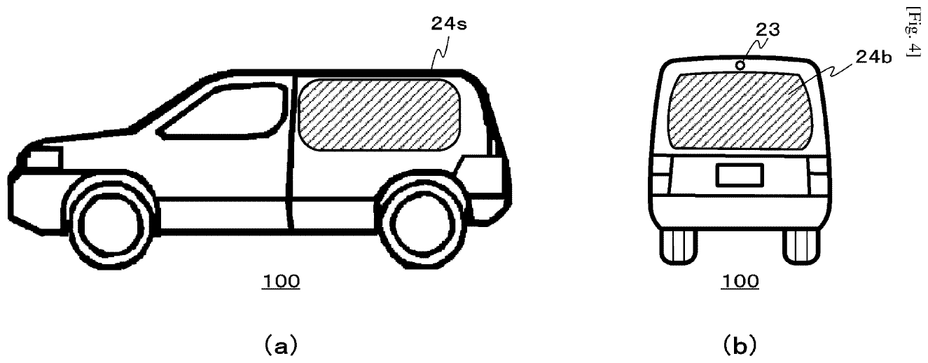

Now, an example of a configuration and an example of operation of a vehicle that uses the information displaying apparatus are described. FIG. 4 exemplifies an appearance of the vehicle that uses the information displaying apparatus of the present technology. It is to be noted that (a) of FIG. 4 exemplifies a side face of the vehicle 100, and (b) of FIG. 4 exemplifies a rear face of the vehicle 100. An information displaying section 24s is provided on a side face of the vehicle 100, and an information displaying section 24b is provided on the rear face. Further, the image capturing section 23 is provided on the upper side of the rear side of the vehicle 100.

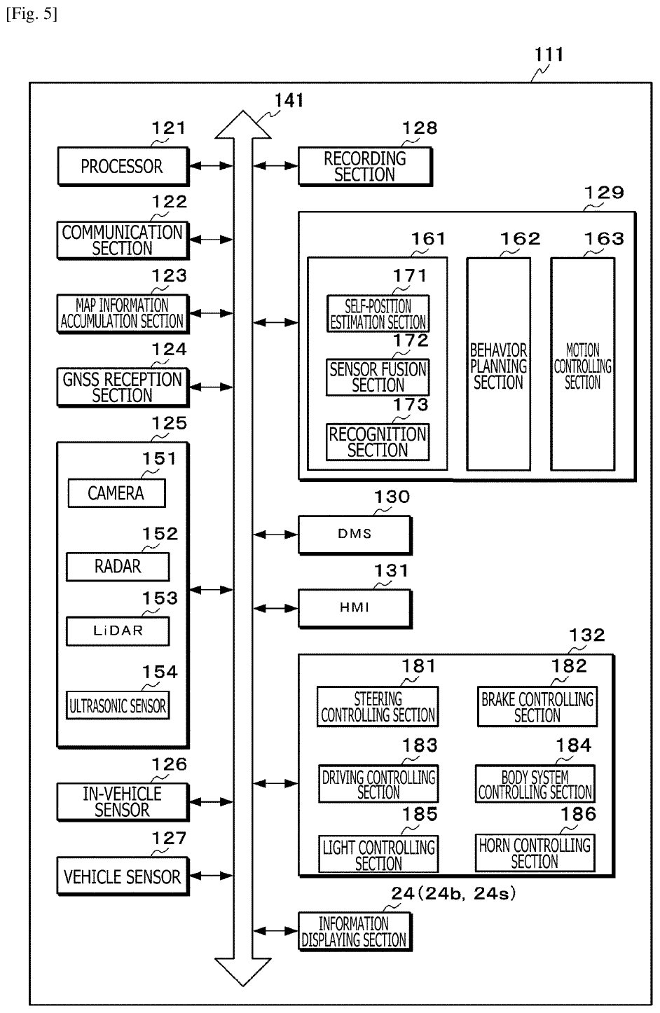

FIG. 5 depicts an example of a functional configuration of the vehicle that uses the information displaying apparatus of the present technology. The vehicle 100 includes a vehicle controlling system 111 and performs processing for travelling support and automatic driving of the vehicle 100. Further, the vehicle controlling system 111 includes functional blocks of the information displaying apparatus of the present technology.

The vehicle controlling system 111 includes a vehicle controlling ECU

(Electronic Control Unit) 121, a communication section 122, a map information accumulation section 123, a position information reception section 124, an outside recognition sensor 125, an in-vehicle sensor 126, a vehicle sensor 127, a recording section 128, a travel support and automatic driving controlling section 129, a DMS (Driver Monitoring System) 130, an HMI (Human Machine Interface) 131, and a vehicle controlling section 132.

The vehicle controlling ECU 121, the communication section 122, the map information accumulation section 123, the position information reception section 124, the outside recognition sensor 125, the in-vehicle sensor 126, the vehicle sensor 127, the recording section 128, the travel support and automatic driving controlling section 129, the driver monitoring system (DMS) 130, the human machine interface (HMI) 131, and the vehicle controlling section 132 are connected for communication with each other through a communication network 141. The communication network 141 includes an onboard communication network, a bus, and so forth compliant with a standard for digital bidirectional communication such as, for example, CAN (Controller Area Network), LIN (Local Interconnect Network), LAN (Local Area Network), FlexRay (registered trademark), or Ethernet (registered trademark). The communication network 141 may be used properly depending upon the type of information to be communicated. For example, for information regarding vehicle control, CAN is applied, and for large capacity information, Ethernet is applied. It is to be noted that the components of the vehicle controlling system 111 are connected directly to each other using wireless communication assuming relatively short-distance communication such as, for example, near field wireless communication (NFC (Near Field Communication)) or Bluetooth (registered trademark) without the intervention of the communication network 141, in some cases.

Note that it is assumed that, in the following description, in a case in which the components of the vehicle controlling system 111 perform communication through the communication network 141, description of the communication network 141 is omitted. For example, in a case in which the vehicle controlling ECU 121 and the communication section 122 communicate with each other through the communication network 141, it is merely described that the vehicle controlling ECU 121 and the communication section 122 communicate with each other.

The vehicle controlling ECU 121 includes various processors such as, for example, a CPU (Central Processing Unit) and an MPU (Micro Processing Unit). The vehicle controlling ECU 121 controls all or part of functions of the vehicle controlling system 111.

The communication section 122 communicates with various pieces of equipment inside and outside the vehicle, other vehicles, an information processing apparatus, a base station, and so forth to transmit and receive various kinds of information. At this time, the communication section 122 can perform communication using a plurality of communication methods.

Communication with the outside of the vehicle that can be executed by the communication section 122 is described briefly. The communication section 122 communicates with an information provision apparatus existing on an external network (such information provision apparatus is hereinafter referred to as an external information provision apparatus) through a base station or an access point by a wireless communication method such as, for example, 5G (fifth generation mobile communication system), LTE (Long Term Evolution), and DSRC (Detailed Short Range Communications). The external network with which the communication section 122 communicates is, for example, the Internet, a cloud network, a network unique to a service provider or the like. The communication method used by the communication section 122 to communicate with an external network is not specifically restrictive if it is a wireless communication method with which digital bidirectional communication is possible at a communication speed equal to or high than a predetermined communication speed and over a distance equal to or greater than a predetermined distance.

Further, for example, the communication section 122 can communicate with a terminal existing in the proximity of the own vehicle using the P2P (Peer To Peer) technology. The terminal existing in the proximity of the own vehicle is, for example, a terminal mounted on a moving apparatus that moves at a comparatively low speed such as a pedestrian or a bicycle, a terminal provided at a fixed position in a shop or the like, or an MTC (Machine Type Communication) terminal. Further, the communication section 122 can also perform V2X communication. The V2X communication signifies communication between the own vehicle and others such as, for example, vehicle to vehicle communication with another vehicle, road to vehicle (Vehicle to Infrastructure) communication with a road-side device, or the like, communication with a home (Vehicle to Home), and pedestrian to vehicle (Vehicle to Pedestrian) communication with a terminal or the like possessed by a pedestrian.

The communication section 122 can receive from the outside, for example, a program for updating software for controlling operation of the vehicle controlling system 111 (Over The Air). The communication section 122 can further receive, from the outside, map information, traffic information, information around the vehicle 100, and so forth. Further, for example, the communication section 122 can transmit, to the outside, information regarding the vehicle 100, information around the vehicle 100, and so forth. The information regarding the vehicle 100 to be transmitted from the communication section 122 to the outside includes, for example, information indicative of a state of the vehicle 100, a result of recognition by a recognition section 173, and so forth. Further, for example, the communication section 122 performs communication compatible with a vehicular emergency reporting system such as the e-call.

Communication with the inside of the vehicle that can be executed by the communication section 122 is described briefly. The communication section 122 can communicate with various pieces of equipment in the vehicle, for example, using wireless communication. The communication section 122 can perform wireless communication with each equipment in the vehicle by a communication method by which digital bidirectional communication can be performed at a communication speed equal to or higher than a predetermined communication speed by wireless communication such as, for example, a wireless LAN, Bluetooth, NFC, or WUSB (Wireless USB). This is not restrictive, and it is also possible for the communication section 122 to perform communication with each equipment in the vehicle using wired communication. For example, the communication section 122 can communicate with each equipment in the vehicle by wired communication through a cable connected to a connection terminal not depicted. The communication section 122 can communicate with each equipment in the vehicle by a communication method by which digital bidirectional communication can be performed at a communication speed equal to or higher than a predetermined communication speed by wired communication such as, for example, USB (Universal Serial Bus), HDMI (registered trademark) (High-Definition Multimedia Interface), or MHL (Mobile High-definition Link).

Here, the equipment in the vehicle signifies equipment that is not connected to the communication network 141 in the vehicle. As the equipment in the vehicle, for example, mobile equipment or wearable equipment possessed by an occupant such as a driver, information equipment carried into and temporarily provided in the inside of the vehicle, and so forth are assumed.

For example, the communication section 122 receives electromagnetic waves transmitted from the road traffic information communication system (VICS (registered trademark) (Vehicle Information and Communication System)) such as a radio beacon, an optical beacon, an FM multiplex broadcast, or the like.

The map information accumulation section 123 accumulates one of or both of a map acquired from the outside and a map created by the vehicle 100. For example, the map information accumulation section 123 accumulates a three-dimensional high precision map, a global map that is low in accuracy than the high-precision map but covers a broader area, and so forth.

The high-precision map is, for example, a dynamic map, a point cloud map, a vector map, or the like. The dynamic map is, for example, a map including four layers of dynamic information, semi-dynamic information, semi-static information, and static information and is provided to the vehicle 100 from an external information provision apparatus or the like. The point cloud map is a map configured from a point cloud (point group information). Here, it is assumed that the vector map signifies a map in which traffic information such as positions of traffic lanes and traffic signals are associated with a point cloud map.

The point cloud map and the vector map may be provided, for example, from an external information provision apparatus or the like or may be created as a map for performing matching with a local map hereinafter described by the vehicle 100 on the basis of a result of sensing by a radar 152, a LiDAR (Light Detection and Ranging, Laser Imaging Detection and Ranging) 153, or the like and accumulated into the map information accumulation section 123. Further, in a case in which a high-precision map is provided from an external information provision apparatus or the like, in order to reduce the communication capacity, map information of, for example, a several-hundred meters square regarding a planned route along which the vehicle 100 is to travel from now on is acquired from an external information provision apparatus or the like.

The position information reception section 124 receives, for example, GNSS

(Global Navigation Satellite System) signals from GNSS satellites to acquire position information regarding the vehicle 100. The received GNSS signals are supplied to the travel support and automatic driving controlling section 129. It is to be noted that the method that uses GNSS signals is not restrictive and the position information reception section 124 may acquire position information, for example, using a beacon.

The outside recognition sensor 125 includes various kinds of sensors used for recognition of a situation of the outside of the vehicle 100, and supplies sensor information from the sensors to the blocks of the vehicle controlling system 111. An external recognition sensor, for example, the outside recognition sensor 125, includes a camera 151, a radar 152, a LiDAR 153, and an ultrasonic sensor 154. This is not restrictive, and the outside recognition sensor 125 may be configured such that it includes one or more kinds of the sensors of the camera 151, the radar 152, the LiDAR 153, and the ultrasonic sensor 154. The number of each of the camera 151, the radar 152, the LiDAR 153, and the ultrasonic sensor 154 is not restricted specifically if it is a number by which such sensors can be actually provided on the vehicle 100. Further, the kinds of sensors provided in the outside recognition sensor 125 are not restricted to those of the example described above, and the outside recognition sensor 125 may include a sensor or sensors of other kinds. An example of sensing regions of the sensors provided in the outside recognition sensor 125 is hereinafter described.

It is to be noted that the image capturing method of the camera 151 is not restricted specifically as long as it is an image capturing method that allows distance measurement. For example, to the camera 151, cameras of various kinds of image capturing methods such as a ToF (Time of Flight) camera, a stereo camera, a monocular camera, and an infrared camera can be applied as occasion demands. This is not restrictive, and the camera 151 may be a camera for merely acquiring a captured image irrespective of distance measurement.

Further, for example, the outside recognition sensor 125 can include an environment sensor for detecting an environment for the vehicle 100. The environment sensor is a sensor for detecting an environment such as the weather, climate, or brightness and can include such various sensors as, for example, a raindrop sensor, a fog sensor, a sunshine sensor, a snow sensor, and an illuminance sensor.

Furthermore, for example, the outside recognition sensor 125 includes a microphone used for detection of sound around the vehicle 100, a position of the sound source, and so forth.

The in-vehicle sensor 126 includes various kinds of sensors for detecting information regarding the inside of the vehicle and supplies sensor information from the sensors to the blocks of the vehicle controlling system 111. The kinds or the number of the sensors provided in the in-vehicle sensor 126 is not specifically restrictive as long as they can be provided actually in the vehicle 100.

For example, the in-vehicle sensor 126 can include one or more kinds of sensors from among a camera, a radar, a seating sensor, a steering wheel sensor, a microphone, and a biosensor. As the camera included in the in-vehicle sensor 126, cameras of various kinds of image capturing methods that allow distance measurement such as, for example, a ToF camera, a stereo camera, a monocular camera, and an infrared camera can be used. This is not restrictive, and the camera provided in the in-vehicle sensor 126 may be a camera for merely acquiring a captured image irrespective of distance measurement. The biosensor provided in the in-vehicle sensor 126 is provided, for example, on the seat, steering wheel, or the like and detects various kinds of biological information regarding an occupant such as a driver.

The vehicle sensor 127 includes various kinds of sensors for detecting a state of the vehicle 100 and supplies sensor information from the sensors to the blocks of the vehicle controlling system 111. The kinds and the numbers of the sensors provided in the vehicle sensor 127 are not restricted specifically as long as they are numbers by which the sensors can be provided actually in the vehicle 100.

For example, the vehicle sensor 127 includes a speed sensor, an acceleration sensor, an angular speed sensor (gyro sensor), and an inertial measurement apparatus (IMU: Inertial Measurement Unit) in which they are integrated. For example, the vehicle sensor 127 includes a steering angle sensor for detecting a steering angle of the steering wheel, a yaw rate sensor, an accelerator sensor for detecting an operation amount of the accelerator pedal, and a brake sensor for detecting an operation amount of the brake pedal. For example, the vehicle sensor 127 includes a rotation sensor for detecting the number of rotations of an engine or a motor, a pneumatic sensor for detecting the tire pressure, a slip rate sensor for detecting the tire slip rate, and a wheel sensor for detecting the number of rotations and the rotational speed of the wheel. For example, the vehicle sensor 127 includes a battery sensor for detecting the remaining capacity and the temperature of the battery and an impact sensor for detecting an impact from the outside.

The recording section 128 includes at least one of a nonvolatile storage medium and a volatile storage medium and stores information and programs. The recording section 128 is used, for example, as an EEPROM (Electrical Erasable Programmable Read Only Memory) and a RAM (Random Access Memory), and as the storage medium, a magnetic storage device such as an HDD (Hard Disc Drive), a semiconductor storage device, an optical storage device, and a photomagnetic storage device can be applied. The recording section 128 records various kinds of programs and information to be used by the blocks of the vehicle controlling system 111. For example, the recording section 128 includes an EDR (Event Data Recorder) and a DSSAD (Data Storage System for Automated Driving) and records information regarding the vehicle 100 before and after an event such as an accident and biological information acquired by the in-vehicle sensor 126.

The travel support and automatic driving controlling section 129 performs travel support and control of automatic driving of the vehicle 100. For example, the travel support and automatic driving controlling section 129 includes an analysis section 161, a behavior planning section 162, and a motion controlling section 163.

The analysis section 161 performs an analysis process of a situation of the vehicle 100 and the surroundings. The analysis section 161 includes a self-position estimation section 171, a sensor fusion section 172, and a recognition section 173.

The self-position estimation section 171 estimates the self position of the vehicle 100 on the basis of sensor information from the outside recognition sensor 125 and a high precision map accumulated in the map information accumulation section 123. For example, the self-position estimation section 171 creates a local map on the basis of the sensor information from the outside recognition sensor 125 and performs matching between the local map and the high-precision map to estimate the self position of the vehicle 100. The position of the vehicle 100 is, for example, determined with reference to the center of the rear wheel pair axles.

The local map is a three-dimensional high-precision map, an occupancy grid map (Occupancy Grid Map), or the like created using the technology of, for example, SLAM (Simultaneous Localization and Mapping) or the like. The three-dimensional high-precision map is, for example, a point cloud map described hereinabove or the like. The occupancy grid map is a map in which a three-dimensional or two-dimensional space around the vehicle 100 is divided into grids (lattices) of a predetermined size and an occupancy state of an object is indicated in a unit of a grid. The occupancy state of an object is indicated, for example, by presence/absence or probability of existence of an object. The local map is, for example, used also in a detection process and a recognition process of an external situation of the vehicle 100 by the recognition section 173.

It is to be noted that the self-position estimation section 171 may estimate the self-position of the vehicle 100 on the basis of GNSS signals and sensor information from the vehicle sensor 127.

The sensor fusion section 172 performs a sensor fusion process of combining a plurality of different types of sensor information (for example, image information to be supplied from the camera 151 and sensor information to be supplied from the radar 152) to obtain new information. As a method of combining different types of sensor information, integration, fusion, union, and so forth are available.

The recognition section 173 executes a detection process of performing detection of an external situation of the vehicle 100 and a recognition process of performing recognition of an external situation of the vehicle 100.

For example, the recognition section 173 performs a detection process and a recognition process of an external situation of the vehicle 100 on the basis of information from the outside recognition sensor 125, information from the self-position estimation section 171, information from the sensor fusion section 172, and so forth.

In particular, for example, the recognition section 173 performs a detection process, a recognition process, and so forth of an object around the vehicle 100. The detection process of an object is a process of detecting, for example, presence/absence, a magnitude, a shape, a position, a motion, and so forth of an object. The recognition process of an object is, for example, a process of recognizing an attribute such as a type of an object or identifying a specific object. However, the detection process and the recognition process are not necessarily different from each other definitely but overlap with each other, in some cases.

For example, the recognition section 173 performs clustering of classifying a point cloud based on sensor information from the LiDAR 153, the radar 152, and so forth for each cluster of the point group to detect an object around the vehicle 100. Accordingly, presence/absence, a size, a shape, and a position of an object around the vehicle 100 are detected.

For example, the recognition section 173 performs tracking of following the movement of a cluster of the point group classified by the clustering to detect a movement of the object around the vehicle 100. Accordingly, a speed and an advancing direction (moving vector) of the object around the vehicle 100 are detected.

For example, the recognition section 173 detects or recognizes a vehicle, a person, a bicycle, an obstacle, a structure, a road, a traffic signal, a traffic sign, a road marking, and so forth from image information supplied from the camera 151. Further, the recognition section 173 may recognize a type of the object around the vehicle 100 by performing a recognition process of semantic segmentation or the like.

For example, the recognition section 173 can perform a recognition process of traffic rules around the vehicle 100 on the basis of the map accumulated in the map information accumulation section 123, a result of estimation of the self position by the self-position estimation section 171, and a result of recognition of objects around the vehicle 100 by the recognition section 173. This process enables the recognition section 173 to recognize the position and the state of traffic signals, contents of traffic signs and road markings, contents of the traffic rules, lanes along which the vehicle 100 can travel, and so forth.

For example, the recognition section 173 can perform a recognition process of an environment around the vehicle 100. The environment around the vehicle 100 that is a target of recognition by the recognition section 173 is assumed to be the weather, temperature, humidity, brightness, state of the road surface, and so forth.

The behavior planning section 162 creates a behavior schedule of the vehicle 100. For example, the behavior planning section 162 performs a process for route planning and route following to create a behavior schedule.

It is to be noted that the route planning (Global path planning) is a process of planning a rough route from a start to a goal. This route planning also includes a trajectory generation (Local path planning) process called trajectory planning that allows safe and smooth advancement in the proximity of the vehicle 100 along the route planned by route planning, taking motion characteristics of the vehicle 100 into consideration. The route planning may be distinguished as long-term route planning, and the trajectory generation may be distinguished as short term path planning, or local path planning. A safe priority route represents a similar concept to the trajectory generation, the short-term route planning, or the local path planning.

Route follow-up is a process of planning operation for travelling along a route planned by the route planning safely and accurately within the planned time. The behavior planning section 162 can calculate a target speed and a target angular velocity of the vehicle 100, for example, on the basis of a result of the route follow-up process.

The motion controlling section 163 controls operation of the vehicle 100 in order to achieve the behavior plan created by the behavior planning section 162.

For example, the motion controlling section 163 controls a steering controlling section 181, a brake controlling section 183, and a driving controlling section 183 included in the vehicle controlling section 132 hereinafter described, to perform acceleration/deceleration control and direction control such that the vehicle 100 advances along the trajectory calculated by the trajectory planning. For example, the motion controlling section 163 performs cooperative control in order to achieve ADAS functions such as collision avoidance or collision mitigation, follow-up travelling, vehicle speed maintaining travelling, collision warning of the own vehicle, and lane departure warning of the own vehicle. For example, the motion controlling section 163 performs cooperative control for the object of automatic driving for autonomous travelling that does not rely upon an operation by the driver, and so forth.

The DMS 130 performs an authentication process of a driver, a recognition process of a state of the driver, and so forth on the basis of sensor information from the in-vehicle sensor 126, input information inputted from the HMI 131 hereinafter described, and so forth. In this case, as the state of the driver that becomes a recognition target of the DMS 130, for example, a physical condition, an arousal, a degree of concentration, a degree of fatigue, a gazing direction, an intoxication degree, a driving operation, a posture, and so forth are supposed.

It is to be noted that the DMS 130 may perform an authentication process of an occupant other than the driver and a recognition process of a state of the occupant. Further, for example, the DMS 130 may perform a recognition process of a situation of the inside of the vehicle on the basis of sensor information from the in-vehicle sensor 126. As the situation of the inside of the vehicle that becomes a recognition target, for example, temperature, humidity, brightness, smell, and so forth are supposed

The HMI 131 performs inputting of various kinds of information and instructions and presentation of various kinds of information to the driver.

Inputting of information by the HMI 131 is described briefly. The HMI 131 includes an inputting device for allowing a person to input information. The HMI 131 generates an input signal on the basis of information, an instruction, or the like inputted by the inputting device and supplies the input signal to blocks of the vehicle controlling system 111. The HMI 131 includes, as the inputting device, operation elements such as, for example, a touch panel, a button, a switch and a lever. This is not restrictive, and the HMI 131 may further include an inputting device that can input information by a method other than a manual operation such as voice or a gesture. Further, the HMI 131 may use, as the inputting device, for example, a remote control device that utilizes infrared rays or radio waves or an externally connected equipment such as a mobile equipment or a wearable equipment compatible with an operation of the vehicle controlling system 111.

Presentation of information by the HMI 131 is described briefly. The HMI 131 performs creation of visual information, auditory information, and tactile information for an occupant or the outside of the vehicle. Further, the HMI 131 performs output control of controlling outputting of the created various kinds of information, output contents, an outputting timing, an outputting method, and so forth. The HMI 131 creates and outputs, as the visual information, information indicated by an image such as, for example, an operation screen image, state display of the vehicle 100, warning display, and/or a monitor image indicative of a situation around the vehicle 100 or by light. Further, the HMI 131 creates and outputs, as the auditory information, information indicated by sound such as, for example, voice guidance, warning sound, a warning message, or the like. Furthermore, the HMI 131 creates and outputs, as the tactile information, information that is given to the tactile of an occupant such as, for example, force, vibration, or motion.

As the outputting device that outputs visual information from the HMI 131, for example, a display device that presents visual information by displaying an image on the display device itself or a projector device that presents visual information by projecting an image can be applied. It is to be noted that the display device may be, in addition to a display device that has an ordinary display, a device that displays visual information in the field of view of an occupant such as, for example, a head-up display, a see-through display, wearable equipment having an AR (Augmented Reality) function, or the like. Further, in the HMI 131, it is also possible to use a display device provided on a navigation apparatus, an instrument panel, a CMS (Camera Monitoring System), an electronic minor, a lamp, or the like provided on the vehicle 100 as an outputting device that outputs visual information.

As the outputting device that outputs auditory information from the HMI 131, for example, an audio speaker, headphones, and earphones can be applied.

As the outputting device that outputs tactile information from the HMI 131, for example, a haptics element that utilizes the haptics technology can be applied. The haptics element is provided at a portion of the vehicle 100 with which an occupant is to touch such as, for example, a steering wheel or a seat.

The vehicle controlling section 132 performs control of the blocks of the vehicle 100. The vehicle controlling section 132 includes a steering controlling section 181, a brake controlling section 183, a driving controlling section 183, a body system controlling section 184, a light controlling section 185, and a horn controlling section 186.

The steering controlling section 181 performs detection, control, and so forth of a state of the steering system of the vehicle 100. The steering system includes, for example, a steering mechanism including the steering wheel and so forth, an electric power steering apparatus, and so forth. The steering controlling section 181 includes, for example, a control unit such as an ECU that performs control of the steering system, an actuator that performs driving of the steering system, and so forth.

The brake controlling section 183 performs detection, control, and so forth of a state of the brake system of the vehicle 100. The brake system includes, for example, a brake mechanism including a brake pedal and so forth, an ABS (Antilock Brake System), a regeneration brake mechanism, and so forth. The brake controlling section 183 includes a control unit such as, for example, an ECU that performs control of the brake system, and so forth.

The driving controlling section 183 performs detection, control, and so forth of the driving system of the vehicle 100. The driving system includes an accelerator pedal, a driving force generation apparatus for generating driving force such as, for example, an internal combustion engine, a driving motor, and so forth, a driving force transmission mechanism for transmitting the driving force to the wheels, and so forth. The driving controlling section 183 includes a control unit such as, for example, an ECU for performing control of the driving system, and so forth.

The body system controlling section 184 performs detection, control, and so forth of a state of a body system of the vehicle 100. The body system includes, for example, a keyless entry system, a smart key system, a power window device, a power seat, an air conditioning apparatus, an airbag, a seatbelt, a shift lever, and so forth. The body system controlling section 184 includes a control unit such as, for example, an ECU for performing control of the body system, and so forth.

The light controlling section 185 performs detection, control, and so forth of a state of various kinds of lights of the vehicle 100. As the lights that become a control target, for example, a headlight, a back light, a fog light, a turn signal, a brake light, a projection, a bumper display, and so forth are supposed. The light controlling section 185 includes a control unit such as an ECU that performs control of the lights, and so forth.

The horn controlling section 186 performs detection, control, and so forth of a state of the car horn of the vehicle 100. The horn controlling section 186 includes a control unit such as, for example, an ECU that performs control of the car horn, and so forth.

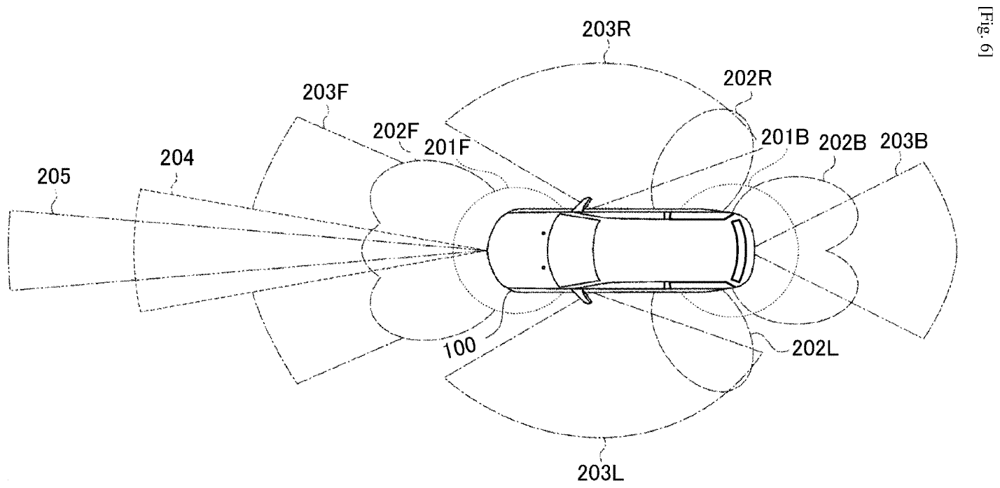

FIG. 6 is a view depicting an example of sensing regions by the camera 151, the radar 152, the LiDAR 153, the ultrasonic sensor 154, and so forth of the outside recognition sensor 125 of FIG. 5. It is to be noted that, in FIG. 6, a state in which the vehicle 100 is viewed from above is schematically depicted, and the left end side is the front end (front) side of the vehicle 100 and the right end side is the rear end (rear) side of the vehicle 100.

A sensing region 201F and a sensing region 201B indicate examples of a sensing region of the ultrasonic sensor 154. The sensing region 201F covers an area around the front end of the vehicle 100 by plural ultrasonic sensors 154. The sensing region 201B covers an area around the rear end of the vehicle 100 by other plural ultrasonic sensors 154.

A result of sensing by the sensing region 201F and the sensing region 201B is used, for example, for parking support of the vehicle 100 and so forth.

A sensing region 202F to a sensing region 202B indicate examples of a sensing region of the radar 152 for a short distance or a medium distance. The sensing region 202F covers an area to a position farther than that of the sensing region 201F in front of the vehicle 100. The sensing region 202B covers an area farther than that of the sensing region 201B in the rear of the vehicle 100. A sensing region 202L covers an area around the rear of the left side face of the vehicle 100. A sensing region 202R covers an area around the rear of the right side face of the vehicle 100.

A result of sensing by the sensing region 202F is used, for example, for detection and so forth of a vehicle, a pedestrian, or the like existing in front of the vehicle 100. A result of sensing by the sensing region 202B is used, for example, for a collision prevention function at the rear of the vehicle 100, and so forth. A result of sensing by the sensing region 202L and the sensing region 202R is used for detection and so forth of an object in a sideward dead angle of the vehicle 100, for example.

A sensing region 203F to a sensing region 203B indicate examples of a sensing region by the camera 151. The sensing region 203F covers an area to a position father than that of the sensing region 202F in front of the vehicle 100. The sensing region 203B covers an area to a position farther than that of the sensing region 202B in the rear of the vehicle 100. The sensing region 203L covers an area around the left side face of the vehicle 100. The sensing region 203R covers an area around the right side face of the vehicle 100.

A result of sensing of the sensing region 203F can be used, for example, for recognition of traffic signals and traffic signs and in a lane departure prevention support system and an automatic headlight controlling system. A result of sensing of the sensing region 203B can be used, for example, for parking support and in a surround view system. A result of sensing of the sensing region 203L and the sensing region 203R can be used, for example, in a surround view system.

A sensing region 204 indicates an example of a sensing region of the LiDAR 153. The sensing region 204 covers an area to a position farther than that of the sensing region 203F in front of the vehicle 100. Meanwhile, the sensing region 204 is narrower in range in the leftward and rightward direction than the sensing region 203F.

A result of sensing of the sensing region 204 is used, for example, for detection of an object such as a surrounding vehicle.

A sensing region 205 indicates an example of a sensing region of the radar 152 for the long distance. The sensing region 205 covers an area to a position farther than that of the sensing region 204 in front of the vehicle 100. Meanwhile, the sensing region 205 is narrower in range in the leftward and rightward direction than the sensing region 204.

A result of sensing of the sensing region 205 is used, for example, for ACC (Adaptive Cruise Control), emergency braking, collision avoidance, and so forth.

It is to be noted that the sensing regions of the sensors including the camera 151, the radar 152, the LiDAR 153, and the ultrasonic sensor 154 included in the outside recognition sensor 125 may have various kinds of configurations other than those of FIG. 6. In particular, the ultrasonic sensor 154 may be configured so as to sense also the sides of the vehicle 100, and the LiDAR 153 may sense the rear of the vehicle 100. Further, the installation positions of the sensors are not restricted to the examples described above. Further, the number of each sensor may be one or a plural number.

In such a vehicle controlling system 111 as described above, the communication section 122 is used also as the communication section 21 of the information displaying apparatus 20. Further, the cameras used for sensing of the sensing region 203F, the camera used for sensing of the sensing region 203B, the HMI 131, and the recognition section 173 are used also as the image capturing section 22, the image capturing section 23, the captured image displaying section 25, and the recognition section 26, respectively. Further, the function of the display controlling section 27 is provided in the travel support and automatic driving controlling section 129, and the information displaying section 24b is provided on the rear face of the vehicle 100 such that the displaying direction thereof is the rearward direction of the vehicle. Further, the communication section 21 of the information displaying apparatus 20 may be portable electronic equipment having a communication function such as a smartphone, a tablet terminal, a laptop personal computer, or the like possessed by an occupant of the vehicle 100.

Now, an example of operation of the vehicle is described with reference to the flow chart depicted in FIG. 3 described hereinabove. At step ST1, the vehicle starts acquisition of captured image information. The vehicle 100 performs sensing of the sensing region 203B, for example, by the image capturing section 22 to acquire captured image information indicating the front of the vehicle (forward captured image information) and performs sensing of the sensing region 203B by the image capturing section 23 to acquire captured image information indicating the rear of the vehicle (rearward captured image information). It is to be noted that the rearward captured image information is displayed as a monitor image on a room mirror of the HMI 131.

At step ST11, the information provision apparatus selects provision information. The information provision apparatus 30 performs selection of provision information to be displayed on the vehicle 100 on the basis of a provision period and provision time, related information regarding the vehicle 100 (for example, current position and route planning of the vehicle 100, weather, and so forth) and selects advertisement information suitable for the current position and route and a peripheral environment (office district, shopping district, or the like, weather, and so forth), the provision period and the provision time including present point of time. For example, in a case in which the vehicle 100 is in an office district in the morning, business-related advertisement information is selected, but in a case in which the vehicle 100 is in a shopping district in the daytime or at night, advertisement information on a shop is selected. Alternatively, on a hot day, advertisement information on a frozen dessert or the like is selected, while on a cold day, advertisement information on a hot drink or the like is selected. Further, on a day on which an event is performed, advertisement information on goods related to the event, advertisement information suitable for a planned route, or the like is selected. The information provision apparatus 30 selects and then transmits provision information suitable for the vehicle 100 to the vehicle 100.

At step ST3, the vehicle determines a display environment. The vehicle 100 acquires a surrounding environment of the vehicle on the basis of an environment sensor provided in the outside recognition sensor 125. In a case where plural pieces of provision information are provided from the information provision apparatus 30, the vehicle 100 selects provision information to be displayed according to the surrounding environment from the provided provision information. Further, the vehicle 100 determines an operation of the vehicle by the vehicle sensor 127. Further, the vehicle 100 changes a display attribute of information to be displayed by the information displaying section 24b according to the operation of the vehicle. For example, the vehicle 100 performs resolution adjustment for the provision information acquired at step ST3 and the captured image information acquired at step ST1 on the basis of a displaying performance and so forth of the information displaying section 24b that performs displaying operation of the information such that the visibility of the information displayed on the information displaying section 24b becomes better. Further, the vehicle 100 performs luminance adjustment according to the brightness around the vehicle at the time of operation and makes, in a case in which the surroundings of the vehicle become dark, the display darker such that the display is not excessively bright. Further, the vehicle 100 performs a display correction process of the provision information and the captured image information according to the displaying direction of the information displaying section on the basis of the mounting state and so forth of the information displaying section 24b that performs displaying operation of information such that the visibility of the information displayed on the information displaying section 24b becomes better. For example, the vehicle 100 performs correction according to the mounting angle of the information displaying section 24b to prevent a quadrangle from being seen as a trapezoidal shape. Furthermore, the vehicle 100 performs display size adjustment and so forth according to the speed of movement of the vehicle such that, in a case in which the speed of movement is high, the display is performed in an enlarged scale such that the display can be seen readily.

At step ST4, the vehicle determines whether or not information display is to be performed. The vehicle 100 controls information to be displayed on the information displaying section 24 according to operation of the vehicle 100. For example, the vehicle 100 switches information to be displayed on the information displaying section 24b to the provision information or the captured image information on the basis of a switching determination condition according to the operation of the vehicle 100. For example, in a case in which the vehicle 100 enters a stopping state, the vehicle 100 displays the forward captured image information on the information displaying section 24b, and in a case in which a stopping state continues for a predetermined period or more, the vehicle 100 switches the image to be displayed to the presentation information. Further, when the vehicle 100 is in a travelling state, the vehicle 100 displays the presentation information on the information displaying section 24b, and in a case in which the vehicle 100 enters a travelling state in a traffic jam section, the vehicle 100 switches the information to be displayed to the forward captured image information. In addition, in a case in which a state in which the distance to a subsequent vehicle is shorter than a predetermined distance continues for a predetermined period, the vehicle 100 may switch the information to be displayed to the rearward captured image information acquired by the image capturing section 23. It is to be noted that the forward captured image information and the rearward captured image information are recorded into the recording section 128.

In a case in which the provision information is to be displayed, the vehicle 100 advances the processing to step ST5, at which it displays the provision information, which has been processed so as to make the visibility better, on the information displaying section 24b. Also, in a case in which the captured image information is to be displayed, the vehicle 100 advances the processing to step ST6, at which it displays the captured image information, which has been processed so as to make the visibility better after being acquired through sensing of the sensing region 203F performed by the image capturing section 22, on the information displaying section 24b.

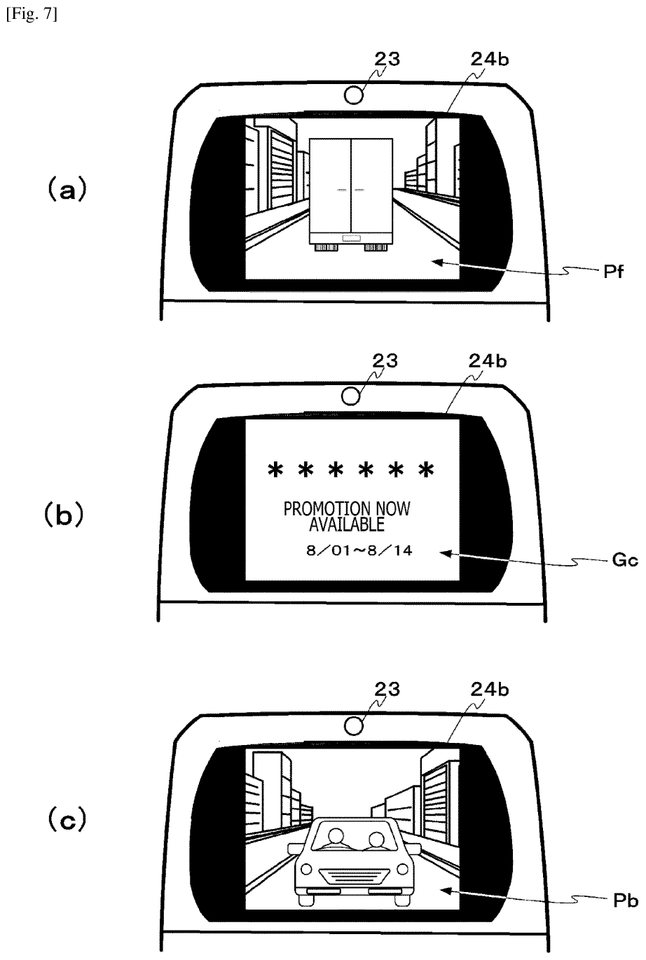

FIG. 7 depicts examples of display of the information displaying section. Subfigure (a) of FIG. 7 exemplifies a case in which forward captured image information is displayed on the information displaying section 24b. The vehicle 100 displays forward captured image information Pf on the information displaying section 24b, so that an occupant of a subsequent vehicle can check in what situation the front of the vehicle 100 is.

Subfigure (b) of FIG. 7 exemplifiers a case in which presentation information is displayed on the information displaying section 24b. The vehicle 100 displays provision information Gc such as an advertisement on the information displaying section 24b, so that the advertisement or the like can be presented to an occupant or the like of a subsequent vehicle.

Subfigure (c) of FIG. 7 exemplifies a case in which rearward captured image information is displayed on the information displaying section 24b. The vehicle 100 displays rearward captured image information Pb on the information displaying section 24b, so that the rearward captured image information Pb can alert an occupant of a subsequent vehicle to the fact that the subsequent vehicle is coming closer to the vehicle 100, or the like. Further, the vehicle 100 can notify a subsequent vehicle that the subsequent vehicle is being recorded.

At step ST7, the vehicle performs a recognition process. The recognition section 173 of the vehicle 100 performs a recognition process using the rearward captured image information acquired by the image capturing section 23 to acquire parameter information regarding a subsequent vehicle. For example, the recognition section 173 estimates the sex and the age of the driver of the subsequent vehicle, the number of occupants, the composition of occupants and so forth. Further, the recognition section 173 determines a vehicle type of the subsequent vehicle (which vehicle type among, for example, sedan, minivan, SUV (Sport Utility Vehicle)) and so forth. Further, the display controlling section 27 of the vehicle 100 may calculate a display effect expected value in accordance with the expression (1) given below utilizing a recognition result of the recognition section 173 and so forth. It is to be noted that, in the expression (1), the estimated number of viewers is, for example, the number of occupants of the subsequent vehicle. The advertisement period is a period of time during which the provision information is displayed on the information displaying section 24b. The weight coefficient is, for example, a coefficient according to a relation between an advertisement and a viewer of the advertisement, and if the viewer is a female and the advertisement is an advertisement for women, then the coefficient is increased.

Display effect expected value=estimated viewer number×advertisement period×weight coefficient (1)

The display controlling section 27 may include the calculated display effect expected value into the display history information. Further, the recognition section 173 transmits the parameter information and so forth regarding the subsequent vehicle as a recognition result to the information provision apparatus 30.

Further, the display controlling section 27 may perform calculation of a display effect expected value, for example, for each piece of advertisement information acquired from the information provision apparatus 30, select the piece of advertisement information whose display effect expected value is highest, and cause the information displaying section 24b to display the piece of advertisement information.

In a case in which the information provision apparatus 30 receives a recognition result at step ST12 and returns the processing to step ST11, it selects and outputs a piece of provision information according to the result of the recognition. For example, in a case in which the type of the subsequent vehicle indicated by the parameter information is a family car, the information provision apparatus 30 selects and outputs advertisement information for families as provision information.

At step ST8, the vehicle determines whether the display is to be ended. In a case in which the vehicle 100 is to end the display of information using the information displaying section 24b, it advances the processing to step ST9, and in a case in which the vehicle 100 is not to end the display, it returns the processing to step ST3.

At step ST9, the vehicle generates display history information. The display controlling section 27 of the vehicle 100 generates display history information including, for example, the name and the display period information regarding the provision information displayed on the information displaying section 24b (for example, a cumulative display time period, display start time, display end time, and so forth), display position information indicating at which position the display is performed, identification information set to the vehicle on which the information is displayed, and so forth. Further, the vehicle 100 transmits the generated display history information to the information provision apparatus 30.

If the information provision apparatus 30 determines at step ST13 that display history information is received and advances the processing to step ST14, then it performs a giving process of an incentive. The information provision apparatus 30 stores the received display history information into the display history database 322 and gives an incentive, for example, to a manager of the vehicle 100 according to display performances of provision information on the vehicle 100 on the basis of the information display history of the vehicle 100 stored in the display history database 322. Further, the information provision apparatus 30 may give an incentive according to a display effect predicted value calculated on the basis of the expression (2) below. In the expression (2), the viewer number is, for example, the number of occupants of the subsequent vehicle during the display period of provision information. The advertisement time is a time period during which provision information is displayed on the information displaying section 24b. The achievement weighting coefficient is a coefficient calculated, for example, according to a relation between provision information and a display place or a viewer, and in an environment in which the number of viewers targeted by provision information is great, the coefficient is made higher.

Display effect predicted value=viewer number×advertisement display time×achievement weighting coefficient (2)

If the display effect predicted value is used to give an incentive in this manner, then giving of an incentive according to a display effect can be performed in comparison with an alternative case in which an incentive is given on the basis of the display time period of provision information. It is to be noted that the incentive may be given not only by receiving a monetary payment, but also by setting a discount rate for insurance and making a reduction rate of the incentive higher as the display effect predicted value increases.

Further, when provision information is to be displayed, the vehicle 100 may display attention information for attracting attention to the information displaying section 24b. As the attention information, after information having high versatility, for example, weather forecast or traffic jam information, is displayed, advertisement information may be displayed. If provision information is displayed after attention is attracted by displaying attention information in this manner, then the visibility of the provision information can be increased.

Further, although the example of operation described above exemplifies a case in which provision information is displayed on the information displaying section 24b provided on the rear face of the vehicle 100, the provision information may otherwise be displayed on the information displaying section 24s provided on a side face of the vehicle 100 as depicted in (a) of FIG. 4. The recognition section performs a recognition process using captured image information acquired by the image capturing section used for sensing of the sensing region 203L and the image capturing section used for sensing of the sensing region 203R. Accordingly, the recognition section can grasp the number or the density of pedestrians, the sexes of pedestrians, time periods in which pedestrians keep staying at a place, and so forth. If the vehicle 100 determines a peripheral environment and so forth on the basis of a result of the recognition and selects provision information to be displayed on the basis of the determined peripheral environment and the result of the recognition, then the vehicle 100 can display an advertisement or the like suitable for pedestrians. Further, the vehicle 100 or the information provision apparatus 30 can perform calculation of a display effect expected value or a display effect predicted value including not only a subsequent vehicle but also pedestrians by using a result of the recognition of captured image information regarding the sensing regions 203L and 203R.

Further, the vehicle 100 may display provision information during parking during which the movement operation is ended. In this case, the vehicle 100 that is not being used can be used as a display medium of provision information. Therefore, the parking period can be used as a displaying period of provision information, so that, for example, the display effect can be increased. It is to be noted that, if electric power necessary for the display of provision information is supplied from a power supply provided separately from the driving power supply for use for driving of the vehicle 100 and so forth, then such a situation can be prevented that electric power of the driving power supply is consumed by the display of the provision information and movement of the vehicle 100 becomes difficult or the distance of movement becomes short. Further, in a case in which the vehicle 100 has a charging function, part of electric power supplied upon charging may be used to display provision information.

The series of processes described in the specification can be executed by hardware, software, or a composite configuration of them. In a case in which the processes by software are to be executed, a program that records the processing sequence is installed into a memory in a computer incorporated in hardware for exclusive use and is executed by the computer. Alternatively, the program can be installed into a computer for universal use, which can execute various kinds of processes, and executed by the computer.

For example, it is possible to record the program in advance on a hard disc, an

SSD (Solid State Drive), or a ROM (Read Only Memory) as a recording medium. Alternatively, it is possible to temporarily or permanently store (record) the program into a removable recording medium such as a flexible disc, a CD-ROM (Compact Disc Read Only Memory), an MO (Magneto optical) disc, a DVD (Digital Versatile Disc), a BD (Blu-ray Disc (registered trademark)), a magnetic disk, or a semiconductor memory card. Such a removable recording medium as just described can be provided as generally-called package software.

Further, the program not only may be installed from a removable recording medium into a computer but also may be transferred from a download site to a computer by wireless or wired transfer through a network such as a LAN (Local Area Network) or the Internet. The computer can receive the program transferred in this manner and install the program on a recording medium such as a built-in hard disk.

It is noted that the effects described in the present specification are merely examples and are not limited. Further, additional effects may be provided. Further, the the present technology should not be construed in a limited manner. The embodiment of the present technology has been disclosed in the form of exemplification, and it is obvious that those skilled in the art can make modifications or substitutions to the embodiments without departing from the scope of the present technology. That is, in order to determine the scope of the present technology, the claims should be taken into consideration.

Further, the information displaying apparatus of the present technology can also take such configurations as described below.
(1)
An information displaying apparatus comprising:
an information display disposed on a vehicle and oriented so content displayed on the information display is visible outside of the vehicle; and
circuitry configured to control the content displayed on the information display, wherein in a first mode the content includes distribution information provided from a content server and in a second mode the content includes captured image information captured by a camera disposed on the vehicle.
(2)
The information displaying apparatus according to (1), wherein
the information display is removably disposed inside the vehicle and on a rear or a side of the vehicle.
(3)
The information displaying apparatus according to (1) or (2), wherein
the circuitry is configured to output history information regarding the distribution information provided in the past.
(4)
The information displaying apparatus according to any one of (1) through (3), wherein
the camera comprises a forward-facing camera,
the information display is disposed on a rear of the vehicle, and
the circuitry is configured to control the content displayed in the first mode to be the distribution information and control the content displayed in the second mode to be the captured image information captured by the forward-facing camera.
(5)
The information displaying apparatus according to any one of (1) through (4), wherein
the circuitry is configured to control the content according to one of a plurality of operation states of the vehicle, at least two of the plurality of operation states of the vehicle including a parked state and a driving state.
(6)
The information displaying apparatus according to (5), wherein
the circuitry is configured to switch the distribution information in the first mode, and the captured image information in the second mode according to which state, of the plurality of operation states, the vehicle is presently operating.
(7)
The information displaying apparatus according to any one of (1) through (6), wherein
the circuitry is configured to control the content displayed on the information display according to a present speed of the vehicle.
(8)
The information displaying apparatus according to any one of (1) through (7), wherein
the circuitry is configured to control the content displayed on the information display according to sensor information generated by a sensor disposed on the vehicle.
(9)
The information displaying apparatus according to any one of (1) through (8), wherein
the circuitry is configured to perform a recognition process on a basis of information provided by one or more sensors that collect peripheral information around the vehicle, and
the circuitry is configured to select distribution information from a plurality of kinds of distribution information, on a basis of a result of the recognition process.
(10)
The information displaying apparatus according to (9), wherein
the information display is disposed on a rear of the vehicle, and
the circuitry is configured to perform the recognition process using peripheral information that includes an image captured by a rear-facing camera.
(11)
The information displaying apparatus according to (9), wherein
the information display is disposed on a side of the vehicle, and
the circuitry is configured to perform the recognition process using peripheral information that includes an image captured by a side-facing camera.
(12)
The information displaying apparatus according to any one of (9) through (11), wherein
the circuitry is configured to output a result of the recognition process to the content server, and
the circuitry is configured to acquire distribution information selected by the content server based on the result of the recognition process.
(13)
The information displaying apparatus according to any one of (1) through (12), wherein
the circuitry is configured to perform a display correction process on the distribution information according to a present speed of the vehicle.
(14)
The information displaying apparatus according to any one of (1) through (13), wherein
the distribution information includes advertisement information.
(15)
The information displaying apparatus according to (14), wherein
the circuitry is configured to calculate a display effect expected value and select the advertisement information from a plurality of kinds of advertisement information, based on the display effect expected value.
(16)
The information displaying apparatus according to (14) or (15), wherein
the distribution information includes attraction information, and
the circuitry is configured to display the advertisement information after displaying the attraction information.
(17)
The information displaying apparatus according to (16), wherein
the attraction information includes one of weather forecast information or traffic jam information.
(18)
The information displaying apparatus according to any one of (1) through (17), wherein
the information display is configured to be powered by electricity supplied from a battery that is different from a battery that starts an engine of the vehicle or powers a drive train of the vehicle.
(19)
An information displaying method comprising:
operating an information display disposed on a vehicle, the information display being oriented to display content that is visible outside of the vehicle; and
controlling with circuitry the content displayed on the information display, wherein the controlling includes
in a first mode of operation, providing distribution information provided from a content server to the information display, and
in a second mode of operation, providing image information that was captured by a camera disposed on the vehicle to the information display.
(20)
A non-transitory computer readable storage medium having computer code stored therein that when executed by a processor cause the processor to perform an information displaying method, the information displaying method comprising:
operating an information display disposed on a vehicle, the information display being oriented to display content that is visible outside of the vehicle; and
controlling with circuitry the content displayed on the information display, wherein the controlling includes
in a first mode of operation, providing distribution information provided from a content server to the information display, and
in a second mode of operation, providing image information that was captured by a camera disposed on the vehicle to the information display.

It should be understood by those skilled in the art that various modifications, combinations, sub-combinations, and alterations may occur depending on design requirements and other factors insofar as they are within the scope of the appended claims or the equivalents thereof.

### REFERENCE SIGNS LIST

10: Information provision system
20: Information displaying apparatus
21: Communication section
22, 23: Image capturing section
24, 24b, 24s: Information displaying section
25: Captured image displaying section
26: Recognition section
27: Display controlling section
30: Information provision apparatus
31: Communication section
32: Database section
33: Information provision controlling section
40: Network
100: Vehicle
111: Vehicle controlling system
321: Provision information database section
322: Display history database section

1. An information displaying apparatus comprising:
an information display disposed on a vehicle and oriented so content displayed on the information display is visible outside of the vehicle; and
circuitry configured to control the content displayed on the information display,
wherein in a first mode the content includes distribution information provided from a content server and in a second mode the content includes captured image information captured by a camera disposed on the vehicle.

2. The information displaying apparatus according to claim 1, wherein
the information display is removably disposed inside the vehicle and on a rear or a side of the vehicle.

3. The information displaying apparatus according to claim 1, wherein
the circuitry is configured to output history information regarding the distribution information provided in the past.

4. The information displaying apparatus according to claim 1, wherein
the camera comprises a forward-facing camera,
the information display is disposed on a rear of the vehicle, and
the circuitry is configured to control the content displayed in the first mode to be the distribution information and control the content displayed in the second mode to be the captured image information captured by the forward-facing camera.

5. The information displaying apparatus according to claim 1, wherein
the circuitry is configured to control the content according to one of a plurality of operation states of the vehicle, at least two of the plurality of operation states of the vehicle including a parked state and a driving state.

6. The information displaying apparatus according to claim 5, wherein
the circuitry is configured to switch the distribution information in the first mode, and the captured image information in the second mode according to which state, of the plurality of operation states, the vehicle is presently operating.

7. The information displaying apparatus according to claim 1, wherein
the circuitry is configured to control the content displayed on the information display according to a present speed of the vehicle.

8. The information displaying apparatus according to claim 1, wherein
the circuitry is configured to control the content displayed on the information display according to sensor information generated by a sensor disposed on the vehicle.

9. The information displaying apparatus according to claim 1, wherein
the circuitry is configured to perform a recognition process on a basis of information provided by one or more sensors that collect peripheral information around the vehicle, and
the circuitry is configured to select distribution information from a plurality of kinds of distribution information, on a basis of a result of the recognition process.

10. The information displaying apparatus according to claim 9, wherein
the information display is disposed on a rear of the vehicle, and
the circuitry is configured to perform the recognition process using peripheral information that includes an image captured by a rear-facing camera.

11. The information displaying apparatus according to claim 9, wherein
the information display is disposed on a side of the vehicle, and
the circuitry is configured to perform the recognition process using peripheral information that includes an image captured by a side-facing camera.

12. The information displaying apparatus according to claim 9, wherein
the circuitry is configured to output a result of the recognition process to the content server, and
the circuitry is configured to acquire distribution information selected by the content server based on the result of the recognition process.

13. The information displaying apparatus according to claim 1, wherein
the circuitry is configured to perform a display correction process on the distribution information according to a present speed of the vehicle.

14. The information displaying apparatus according to claim 1, wherein
the distribution information includes advertisement information.

15. The information displaying apparatus according to claim 14, wherein
the circuitry is configured to calculate a display effect expected value and select the advertisement information from a plurality of kinds of advertisement information, based on the display effect expected value.

16. The information displaying apparatus according to claim 14, wherein
the distribution information includes attraction information, and
the circuitry is configured to display the advertisement information after displaying the attraction information.

17. The information displaying apparatus according to claim 16, wherein
the attraction information includes one of weather forecast information or traffic jam information.

18. The information displaying apparatus according to claim 1, wherein
the information display is configured to be powered by electricity supplied from a battery that is different from a battery that starts an engine of the vehicle or powers a drive train of the vehicle.

19. An information displaying method comprising:
operating an information display disposed on a vehicle, the information display being oriented to display content that is visible outside of the vehicle; and
controlling with circuitry the content displayed on the information display, wherein the controlling includes
in a first mode of operation, providing distribution information provided from a content server to the information display, and
in a second mode of operation, providing image information that was captured by a camera disposed on the vehicle to the information display.

20. A non-transitory computer readable storage medium having computer code stored therein that when executed by a processor cause the processor to perform an information displaying method, the information displaying method comprising:
operating an information display disposed on a vehicle, the information display being oriented to display content that is visible outside of the vehicle; and
controlling with circuitry the content displayed on the information display, wherein the controlling includes
in a first mode of operation, providing distribution information provided from a content server to the information display, and
in a second mode of operation, providing image information that was captured by a camera disposed on the vehicle to the information display.
